(19) United States
(12) Patent Application Publication
(10) Pub. No.: US 2026/0247157 A1
(43) Pub. Date: Aug. 20, 2026

(54) SYSTEM AND METHOD FOR CENTRALIZED LAWFUL INTERCEPTION IN A NETWORK

(71) Applicant: JIO PLATFORMS LIMITED, Ahmedabad (IN)

(72) Inventors: Arun DEWNA, Rajasthan (IN); Aarthi MUTHUPANDI, Maharashtra (IN); Akanksha SHUKLA, Uttar Pradesh (IN); Utkarsh MADDHESHIYA, Uttar Pradesh (IN); Rushikesh PAWAR, Maharashtra (IN); Anushka RAWAT, Delhi (IN); Aayush BHATNAGAR, Navi Mumbai (IN)

(73) Assignee: JIO PLATFORMS LIMITED, Ahmedabad (IN)

(21) Appl. No.: 18/993,210

(22) PCT Filed: Mar. 13, 2024
(86) PCT No.: PCT/IN2024/050258

§ 371 Date: Jan. 10, 2025

(30) Foreign Application Priority Data
Mar. 29, 2023 (IN) 202321023231

(51) Int. Cl. H04W 12/80

(52) U.S. Cl. CPC H04W 12/80

(57) ABSTRACT

The present disclosure provides a system (110) and a method for centralized lawful interception in a network. The system (110) is a cost effective and centralized solution that helps in streamlining of LI provisioning to a single network function (NF) or a cluster of NFs efficiently, as all the provisioning requests will be handled and limited to a centralized lawful interception function (CLIF) (112) only and will not be extended to NFs. All procedures pertaining to the provisioning and interception will be offloaded to the CLIF (112) and application.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to mobile communications technology in a communications network. More particularly, the present disclosure relates to a system and a method for centralized lawful interception in a network that provides streamlining of LI provisioning to a single network function (NF) or a cluster of NFs efficiently.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Short message service (SMS) interception is required in many countries by local authorities for meeting regulatory compliances and investigating serious crimes. Lawful interception (LI) provides monitoring of SMS contents and SMS-related information on the conversations and actions of mobile subscribers. A short message service function (SMSF) is required to send IRI (interception-related information) to authorities when a subscriber is intercepted. IRI is the collection of information or data associated with telecommunication services involving subscriber identity, communication-associated information, or data (including unsuccessful communication attempts), and location information.

As per the regulatory requirements, there is a need to provide lawful interception in mobile communications for both voice-based services and message-based services. However, the presently available systems, and methods are prone to errors in implementation.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method with a cost-effective and centralized solution that helps in streamlining of LI provisioning to a single network function (NF) or a cluster of NFs efficiently.

It is an object of the present disclosure to provide a system and a method with a centralized lawful interception function (CLIF) that manages provisioning and interception functions efficiently.

It is an object of the present disclosure to provide a system and a method for CLIF deployment and functioning.

It is an object of the present disclosure to provide a system and a method that may be adapted for any LI Solution, in any node.

It is an object of the present disclosure to provide a system and a method for integration with a LIM (lawful interception management).

It is an object of the present disclosure to provide a system and a method for an advanced communication system.

It is an object of the present disclosure to enable implementation of one or more security related aspects in communication system.

### SUMMARY

The present disclosure discloses a system for providing centralized lawful interception in a network. The system includes an administration function (ADMF), a short message service function (SMSF), and a centralized lawful interception function (CLIF). The ADMF is configured to generate a tracing request for tracing a target user equipment (UE). The SMSF is configured to cooperate with the ADMF to receive the generated tracing request and is further configured to receive a user activation signal along with at least one user equipment (UE) identifier from the target UE through a network function. The SMSF is configured to store the received tracing request and the received at least one user equipment identifier in a database. The SMSF is configured to receive an event for each mobile originated (MO) message and mobile terminated (MT) message from the network function. The SMSF is configured to forward the received tracing request and the received event for each MO message and MT message to the CLIF. The CLIF is coupled to the SMSF to receive the tracing request and the event. The CLIF is configured to extract a plurality of information from the received event. The CLIF is configured to compare the at least one user equipment identifier stored in the database corresponding to the tracing request with the extracted plurality of information and traces all the related details of the target UE and at least one UE communicating with the target UE to generate a provisioning information based on comparison. The CLIF is configured to transmit the generated provisioning information to a law enforcement monitoring facility (LEMF), via an identified mediation and delivery function (MDF).

In an embodiment, the ADMF includes a lawful interception provisioning function (LIPF), and a lawful interception control function (LICF).

In an embodiment, the plurality of information includes at least one user equipment (UE) identifier of the target UE, at least one user equipment (UE) identifier of the at least one UE communicating with the target UE, message payload, location information, and PLMN information.

In an embodiment, the tracing request includes a public land mobile network (PLMN) identifier, a message type, a mediation and delivery function (MDF) identifier, and a correlation information.

In an embodiment, the SMSF sends the event for each mobile originated (MO) and mobile terminated (MT) message to the CLIF over a communication fabric.

In an embodiment, the at least one user equipment (UE) identifier includes a subscription permanent identifier (SUPI), a subscriber concealed identifier (SUCI), and a generic public subscription identifier (GPSI).

In an embodiment, the ADMF is configured to generate the tracing request for the target UE on receiving a warrant from a law enforcement agency (LEA).

In an embodiment, the CLIF is configured to store the generated provisioning information in the database.

In an embodiment, the CLIF is configured to transmit the generated provisioning information to the identified mediation and delivery function (MDF) over a secured Transmission Control Protocol (TCP) connection.

In an embodiment, the CLIF is configured to retransmit the generated provisioning information after a predefined time interval if any delivery failure occurred.

In an embodiment, the SMSF acts as a point of interception (POI) that derives the generated provisioning information form the CLIF and delivers the derived provisioning information to a plurality of mediation and delivery functions (MDFs).

In an embodiment, the system includes a triggering function that is configured to receive the tracing request from the LIPF and is further configured to trigger the POI based type of data to be sent by the POI to the identified MDF.

The present disclosure discloses a method of providing centralized lawful interception in a network. The method includes generating, from an administration function (ADMF), a tracing request for tracing a target user equipment (UE). The method includes receiving, by a short message service function (SMSF), the generated tracing request. The method includes receiving, by the SMSF, a user activation signal along with at least one user equipment identifier from the target UE through a network function. The method includes storing, by the SMSF, the received tracing request, and the received at least one user equipment identifier in a database. The method includes receiving, by the SMSF, an event for each mobile originated (MO) message and mobile terminated (MT) message from the network function. The method includes forwarding, by the SMSF, the received tracing request and the received event to a centralized lawful interception function (CLIF). The method includes extracting, by the CLIF, a plurality of information from the received event. The method includes comparing, by the CLIF, the at least one user equipment identifier stored in the database corresponding to the tracing request with the extracted plurality of information and tracing all the related details of the target UE and at least one UE communicating with the target UE to generate a provisioning information based on comparison. The method includes transmitting, by the CLIF, the generated provisioning information to a law enforcement monitoring facility (LEMF), via an identified mediation and delivery function (MDF).

In an embodiment, the method includes sending the event for each mobile originated (MO) and mobile terminated (MT) message to the CLIF over a communication fabric.

In an embodiment, the method includes generating, by the ADMF, the tracing request for the target UE on receiving a warrant from a law enforcement agency (LEA).

In an embodiment, the method includes storing, by the CLIF, the generated provisioning information in the database.

In an embodiment, the method includes transmitting, by the CLIF, the generated provisioning information to the identified mediation and delivery function (MDF) over a secured Transmission Control Protocol (TCP) connection.

In an embodiment, the method includes retransmitting, by the CLIF, the generated provisioning information after a predefined time interval if any delivery failure occurred.

In an embodiment, the method includes deriving, by the SMSF acts as a point of interception (POI), the generated provisioning information form the CLIF and delivering the derived provisioning information to a plurality of mediation and delivery functions (MDFs).

In an embodiment, the method includes receiving, by a triggering function, the tracing request from the LIPF and triggering the POI based type of data to be sent by the POI to the identified MDF.

The present disclosure discloses a centralized lawful interception function (CLIF) for providing centralized lawful interception in a network. The CLIF includes a processing unit configured to receive, from an administration function (ADMF), a request for tracing a target user equipment (UE). The CLIF is configured to receive, via a short message service function (SMSF), an event for each mobile originated (MO) message and mobile terminated (MT) message from a network function. The CLIF is configured to extract a plurality of information from the received event. The CLIF is configured to compare, at least one user equipment identifier stored in the database corresponding to the tracing request with the extracted plurality of information and trace all the related details of the target UE and at least one UE communicating with the target UE to generate a provisioning information based on comparison. The CLIF is configured to transmit the generated provisioning information to a law enforcement monitoring facility (LEMF), via an identified mediation and delivery function (MDF).

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture of a system for providing centralized lawful interception in a network, in accordance with an embodiment of the present disclosure.

FIG. 2 illustrates an exemplary representation of the system for providing centralized lawful interception (LI) in a network, in accordance with an embodiment of the present disclosure.

FIG. 3 illustrates an exemplary high-level architecture of the system, in accordance with an embodiment of the present disclosure.

FIG. 4 illustrates an exemplary high level LI architecture with a point to point key LI interface, in accordance with an embodiment of the present disclosure.

FIG. 5 illustrates an exemplary centralized lawful interception function (CLIF) architecture and deployment, in accordance with an embodiment of the present disclosure.

FIG. 6 illustrates an exemplary short message service function (SMSF) integration with the CLIF, in accordance with an embodiment of the present disclosure.

FIG. 7 illustrates an exemplary X1 destination identification (ID) provisioning, in accordance with an embodiment of the present disclosure.

FIG. 8 illustrates an exemplary X1 activate task provisioning, in accordance with an embodiment of the present disclosure.

FIG. 9 illustrates an exemplary destination ID (DS-TID) data structure, in accordance with an embodiment of the present disclosure.

FIG. 10 illustrates an exemplary user activation on SMSF, in accordance with an embodiment of the present disclosure.

FIG. 11 illustrates an exemplary computer system in which or with which the system may be implemented, in accordance with an embodiment of the present disclosure.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—User Equipments
110—System
112, 614—Centralized Lawful Interception Function (CLIF)
202—One or more processor(s)
204—Memory
206—A Plurality of Interfaces
208—Processing Engine
210, 610—Database
212—Data Parameter Engine
302, 402—System Information Retrieval Function (SIRF)
304, 404, 504, 604—Lawful Interception Provisioning Function (LIPF)
306—Lawful Interception Control Function (LCF)
308—Triggering Function (TF) module
310, 312—Point of Interception (POI)
314—Mediation And Delivery Function Module (MDF)
316, 428—Law Enforcement Monitoring Facility (LEMF) module
318—Law Enforcement Agency (LEA)
320, 440—Administration Function (ADMF)
1110—External Storage Device
1120—Bus
1130—Main Memory
1140—Read Only Memory
1150—Mass Storage Device
1160—Communication Port
1170—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

Radio Access Technology (RAT) refers to the technology used by mobile devices/user equipment (UE) to connect to a cellular network. It refers to the specific protocol and standards that govern the way devices communicate with base stations, which are responsible for providing the wireless connection. Further, each RAT has its own set of protocols and standards for communication, which define the frequency bands, modulation techniques, and other parameters used for transmitting and receiving data. Examples of RATs include GSM (Global System for Mobile Communications), CDMA (Code Division Multiple Access), UMTS (Universal Mobile Telecommunications System), LTE (Long-Term Evolution), and 5G. The choice of RAT depends on a variety of factors, including the network infrastructure, the available spectrum, and the mobile device's/device's capabilities. Mobile devices often support multiple RATs, allowing them to connect to different types of networks and provide optimal performance based on the available network resources.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

As per the regulatory requirements, there is a need to provide lawful interception in mobile communications for both voice-based services and message-based services. However, the presently available system and methods are prone to errors in implementation, and hence, there is a need to provide a system and method for lawful interception that may specifically track down message-based communication. SMS interception is required in many countries by local authorities to meet regulatory compliance and to prevent and investigate serious crimes. Lawful interception (LI) provides the operator with a flexible and versatile way to meet the requirements through monitoring SMS contents and SMS-related information on the conversations and actions of mobile subscribers.

SMSF is required to send interception-related information to authorities who order the operator to intercept a subscriber. Interception-Related Information (IRI) is the collection of information or data associated with telecommunication services involving subscriber identity and other specific, communication-associated information or data (including unsuccessful communication attempts), as well as data and location information.

The present disclosure discloses a system and method for lawful interception in a network. The disclosure provides a cost-effective and centralized solution that helps streamline LI provisioning to a single NF or a cluster of NFs efficiently. All the provisioning requests are handled and limited to a CLIF system.

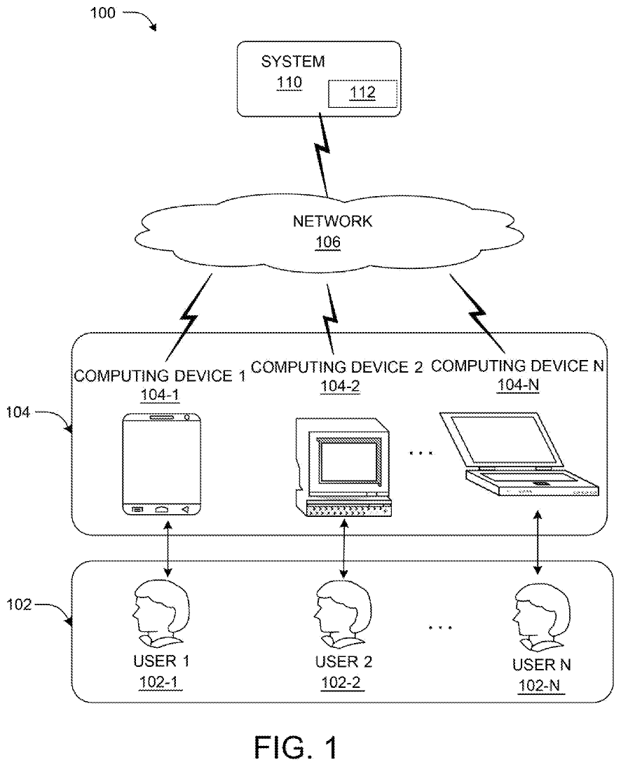

The various embodiments throughout the disclosure will be explained in more detail with reference to FIG. 1-FIG. 11.

FIG. 1 illustrates an exemplary network architecture (100) of a system for providing centralized lawful interception in a network (referred as “system 110”), in accordance with an embodiment of the present disclosure. In an aspect, the system 110 is also referred to as a centralized lawful interception function (CLIF) that can be embedded with or within a short message service function (SMSF). As illustrated in FIG. 1, one or more computing devices (104-1, 104-2 . . . 104-N) are connected to the system (110) through a network (106). A person of ordinary skill in the art will understand that one or more computing devices (104-1, 104-2 . . . 104-N) may be collectively referred as computing devices (104) and individually referred as a computing device (104). Further, the one or more computing devices (104) may also be referred as network entity/entities (NE) (104). One or more users (102-1, 102-2 . . . 102-N) operate the computing devices (110). A person of ordinary skill in the art will understand that the one or more users (102-1, 102-2 . . . 102-N) may be collectively referred as users (102) and individually referred as user (102).

In an embodiment, the computing device (104) includes, but not be limited to, a mobile, a laptop, etc. Further, the computing device (104) includes one or more in-built or externally coupled accessories including, but not limited to, a visual aid device such as a camera, audio aid, microphone, or keyboard. Further, the computing device (104) includes a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like may be used. In an embodiment, users/customers may submit their complaints through the computing devices (104) as shown in FIG. 1.

In an embodiment, the network (106) includes, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

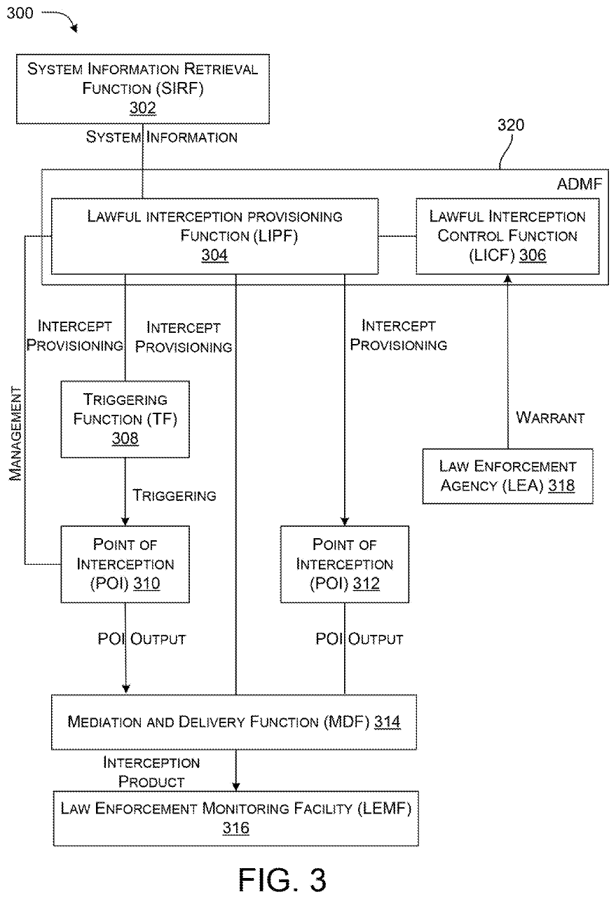

Referring to FIG. 3, the system (110) includes an administration function (ADMF) (320), a short message service function (SMSF), and a centralized lawful interception function (CLIF) (112). The ADMF (320) is configured to generate a tracing request for tracing a target user equipment (UE). The ADMF (320) includes a lawful interception provisioning function (LIPF) (304), and a lawful interception control function (LICF) (306). The ADMF (320) is configured to generate the request for tracing the target UE on receiving a warrant from a law enforcement agency (LEA) (318).

The SMSF is configured to cooperate with the ADMF to receive the generated tracing request and is further configured to receive a user activation signal along with at least one user equipment (UE) identifier from the target UE through a network function. In an example, the network function is an access and mobility management function (AMF). In an example, the tracing request includes a public land mobile network (PLMN) identifier, a message type, a mediation and delivery function (MDF) identifier, and a correlation information. For example, the least one user equipment (UE) identifier includes a subscription permanent identifier (SUPI), a subscriber concealed identifier (SUCI), and a generic public subscription identifier (GPSI).

The SMSF is configured to store the received tracing request and the received at least one user equipment identifier in a database. The SMSF is configured to receive an event for each mobile originated (MO) message and mobile terminated (MT) message from the network function. The SMSF is configured to forward the received tracing request and the received event for each MO message and MT message to the CLIF. In an embodiment, the SMSF sends the event for each mobile originated (MO) message and mobile terminated (MT) message to the CLIF over a communication fabric. In an example, the communication fabric is a system interconnect that facilitates data and control transmissions across various components such as core complex, graphics complex, I/O interfaces, memory controllers, display controller, and multimedia engine. In an embodiment, the SMSF acts as a point of interception (POI) that derives the generated provisioning information form the CLIF and delivers the derived provisioning information to a plurality of mediation and delivery functions (MDFs). The CLIF is coupled to the SMSF to receive the tracing request and the event. The CLIF (112) is configured to extract a plurality of information from the received event. The CLIF (112) is configured to verify the received request for the target UE by mapping the extracted plurality of information with a set of predefined parameters stored in the database. After verifying the target UE, the CLIF (112) is configured to receive a plurality of messages from the SMSF. In an example, the plurality of messages includes a mobile originated (MO) message, a mobile terminated (MT) message, a plurality of UE identifiers of an originating UE, a plurality of UE identifiers of a terminating UE, a message payload, a location information, and a PLMN information.

The CLIF is configured to extract a plurality of information from the received event. In an example, the plurality of information includes at least one user equipment (UE) identifier of the target UE, at least one user equipment (UE) identifier of the at least one UE communicating with the target UE, message payload, location information, and PLMN information. The CLIF is configured to compare the at least one user equipment identifier stored in the database corresponding to the tracing request with the extracted plurality of information. For example, the tracing request has a UE identifier having value 24542 and the UE identifier corresponding to the MO message is 24542. In this case, the CLIF is configured to gather all the information regarding the target UE. The information further includes details of at least one user equipment with whom the target UE is communicating, and all the messages (text) exchanged between both of them. The CLIF is configured to trace all the related details of the target UE and the at least one UE communicating with the target UE to generate a provisioning information based on comparison (if user equipment identifier stored in the database corresponding to the tracing request matched with the extracted plurality of information). The CLIF is configured to transmit the generated provisioning information to a law enforcement monitoring facility (LEMF), via an identified mediation and delivery function (MDF). In an aspect, the CLIF is configured to store the generated provisioning information in the database.

In an aspect, the CLIF is configured to transmit the generated provisioning information to the identified mediation and delivery function (MDF) over a secured Transmission Control Protocol (TCP) connection. In another aspect, the CLIF is configured to retransmit the generated provisioning information after a predefined time interval if any delivery failure occurred.

In an embodiment, the system includes a triggering function that is configured to receive the tracing request from the LIPF and is further configured to trigger the POI based type of data to be sent by the POI to the identified MDF.

In an embodiment, the triggering function detects a point of interception (POI) associated with the one or more tracing requests.

In an embodiment, the system (110) receives the one or more requests with a corresponding destination identifier (DID). Further, in an embodiment, the system (110) rejects the one or more requests based on a service type.

In an operative aspect, the CLIF (112) receives a target identifier associated with the intercepted related information. In an embodiment, the CLIF (112) verifies a target identifier with the one or more requests stored in the database and processes the intercepted related information based on the verification.

In an embodiment, the system (110) sends a request to the CLIF (112) that includes but not limited to a subscription permanent identifier (SUPI), a general public subscription identifier (GPSI), and an international mobile equipment identity (IMEI).

In an embodiment, the CLIF (112) receives the request from the system (110) and query a data structure associated with the request to determine a provisioning associated with the intercepted related information. Further, in an embodiment, the CLIF (112) includes a cluster with one or more nodes to process the intercepted related information.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

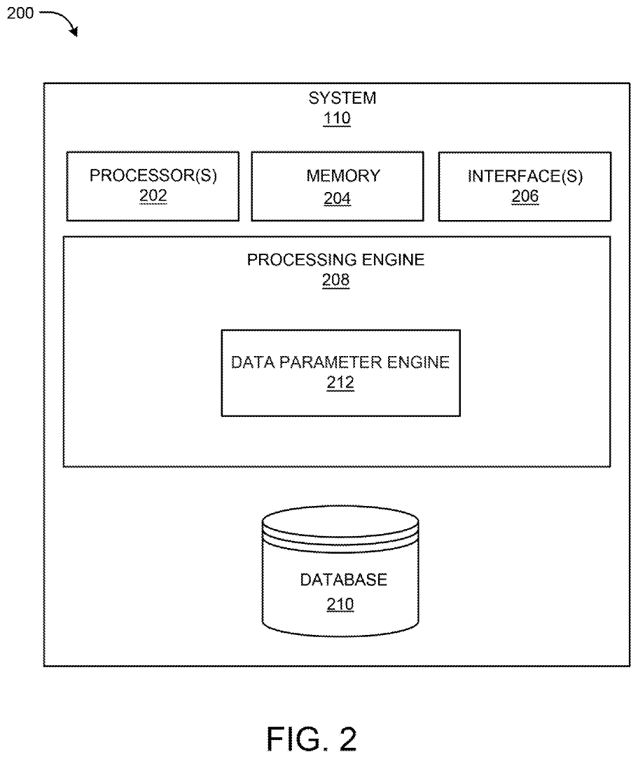

FIG. 2 illustrates an exemplary representation (200) of a system (110), in accordance with an embodiment of the present disclosure.

Referring to FIG. 2, the system (110) includes one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) is configured to store one or more computer-readable instructions or routines in a non-transitory computer readable storage medium, which may be fetched and executed to create or share data packets over a network service. In an aspect, the memory (204) is configured to store the received requests. In another aspect, the memory (204) is configured to store the set of predefined parameters corresponding to each UE identifier. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) includes an interface(s) (206). The interface(s) (206) comprises a variety of interfaces, for example, interfaces for data input and output devices (I/O), storage devices, and the like. The interface(s) (206) facilitates communication through the system (110). The interface(s) (206) also provides a communication pathway for one or more components of the system (110). Examples of such components include, but are not limited to, processing engine(s) (208), a database (210), and a data parameter engine (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) receives one or more requests from one or more computing devices (104) via the data parameter engine (212). The one or more requests include but not limited to an identifier, a message type, and a destination identification (ID). Further, the processor (202) stores the one or more communication requests in the database (210).

In an embodiment, the processor (202) is configured to detect a point of interception (POI) associated with the one or more communication requests. Further, the processor (202) is configured to generate the POI as an intercepted related information.

In an embodiment, the processor (202) is configured to receive the one or more requests with a corresponding destination identifier (DID). Further, in an embodiment, the processor (202) is configured to reject the one or more communication requests based on a service type. In an embodiment, the processor (202) may receive an intercepted related information with the corresponding (DID) from the computing devices (104).

In an embodiment, the processor (202) is configured to receive a target identifier associated with the intercepted related information. In an embodiment, the processor (202) is configured to verify a target identifier with the one or more communication requests stored in the database and process the intercepted related information based on the verification. In an embodiment, the processor (202) is configured to process a request that may include, but not limited to, a subscription permanent identifier (SUPI), a general public subscription identifier (GPSI), and an international mobile equipment identity (IMEI).

In an embodiment, the processor (202) is configured to query a data structure associated with the request to determine a provisioning associated with the intercepted related information. Further, in an embodiment, the processor (202) may include a cluster with one or more nodes to process the intercepted related information.

FIG. 3 illustrates an exemplary high-level architecture (300) of the system (110), in accordance with an embodiment of the present disclosure.

In an embodiment, the system (110) includes functionalities to support multiple short message services (SMS) over a non-access stratum (NAS). The system (110) includes LI capabilities to generate intercepted related information (xIRIs) when the SMS related to the target computing device (104) is processed. The ADMF (320) includes a lawful interception provisioning function (LIPF) module (304), and a lawful interception control function (LICF) module (306).

As illustrated in FIG. 3, in an embodiment a system information retrieval function (SIRF) module (302) is configured to send a system information to a lawful interception provisioning function (LIPF) module (304). Further, the LIPF module (304) is connected to a lawful interception control function (LCF) module (306).

In an embodiment, the LIPF module (304) is configured to process the system information and provide intercept provisioning to a triggering function (TF) module (308). Further, the LIPF module (304) is configured to send the intercept provisioning to a mediation and delivery function module (MDF) module (314) and a corresponding point of interception (POI) module (312).

In an embodiment, the TF module (308) is configured to provide a triggering to a corresponding POI module (310). Further, the LIPF module (304) is configured to provide a required management to the POI module (310).

In an embodiment, the corresponding POI module (310, 312) is configured to send a POI output to the MDF module (314). Further, the MDF module (314) is configured to process the POI output and send an interception product to a law enforcement monitoring facility (LEMF) module (316).

In an embodiment, a law enforcement agency (LEA) module (318) is connected the LICF module (306) and provides a warrant to the LICF module (306).

In an embodiment, the system (110) with a LI architecture may serve as a communication service provider (CSP). On issuance of warrant by the LEA, the LICF module (306) communicates with the LIPF module (304) which in turn provisions a target computing device in the CSP that is supposed to be intercepted. The intercepted messages are fed to the central authorized (MDF) module (314) which delivers the interception product to the LEMF module (316).

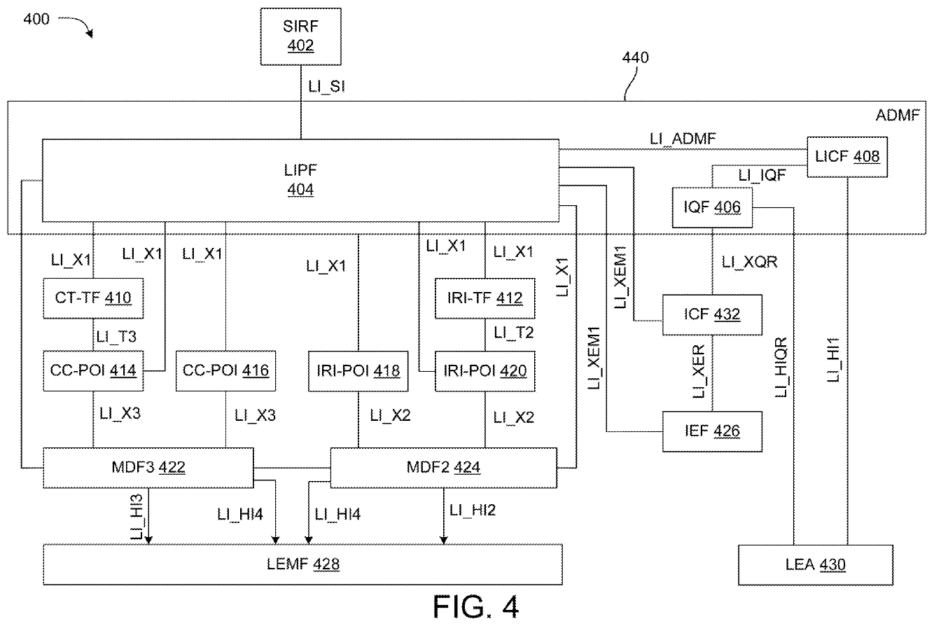

FIG. 4 illustrates an exemplary high level LI architecture (400) with a point to point key LI interface, in accordance with an embodiment of the present disclosure.

In an embodiment, the system (110) interacts with the LIPF module (304) (from FIG. 3) for provisioning and the MDF module (314) (from FIG. 3) for providing feeds. The corresponding POI module (310, 312) (from FIG. 3) may detect the target communication, derive the intercept-related information or communications content from the target communication and deliver the POI output as xIRI to a MDF2 or as a xCC (content of communication) to a MDF3. Further, MDF2 and MDF3 may be two variations of the MDF module (314).

In an embodiment, the MDF2 generates one or more IRI messages from the xIRI and sends them to one or more LEMFs. The MDF3 generates a content of communication (CC) from the xCC and delivers the CC to one or more intercepting LEMFs.

In an embodiment, a LI_HI1 is an interface used to send warrant and other interception request information from the law enforcement agency (LEA) (430) to the CSP. This interface is an electronic or an offline manual process depending on national warranty processes.

The ADMF (440) includes a lawful interception provisioning function (LIPF) (404), and a lawful interception control function (LICF) (408). In an embodiment, LI_ADMF is an interface between the LICF (408) and the LIPF (404) and is used by the LICF (408) to send the intercept provisioning information to the LIPF (404).

In an embodiment, LI_S1 is an interface between the SIRF (402) and LIPF (404). The SIRF (402) uses the LI_SI interface to provide the system information to the LIPF (404). The LIPF (404) requests the SIRF (402) for such information before sending the intercept provisioning information to the POIS (414, 416, 418, 420).

In an embodiment, LI_X1 is an interface for managing the POIS (414, 416, 418, 420) and one or more transfer formats (TFs) (410, 412) to provision LI target information on the POIs (414, 416, 418, 420) and the one or more TFs (410, 412) in order to intercept target communications. LI_X1 interfaces is also be used to manage and provision MDFs (422, 424) with the necessary information to deliver those communications in the correct format to LEMF (428). Provisioning the intercept information may be associated with the target identities of the SUPI, a permanent equipment identifier (PEI), and a general public subscription identifier (GPSI) to the IRI-POI present in the system (110).

In an embodiment, one or more LI_X2 interfaces is used to pass xIRI from IRI-POIs to the MDF2. The IRI-POI present in the system (110) is configured to detect the target computing device SMS and generate the xIRI to the MDF2 over LI_X2. The xIRI contains the SMS payload. The target identifier, a corresponding time stamp, a correlation information, and an IRI event resulting in xIRI may be provided to the MDF2 as a part of xIRI.

In an embodiment, LI_HI2 is an interface used to send the IRI from the MDF2 to the LEMF (428).

In an embodiment, an identity caching function (ICF) (432) and an identity event function (IEF) (426) are connected to the LIPF (404) via the L1_XEM1 interface. Further, IQF (406) is connected to the LICF (408) via a LI_IQF interface and to the ICF (432) via a L1_XQR interface.

In an embodiment, LI_HI4 is an interface used by the MDF2 and the MDF3 to report to the LEMF (428) so that the MDF2/MDF3 may be provisioned as expected. Further, the LI_HI4 interface is used to send LI notification information from MDF2/MDF3 to the LEMF (428).

In an embodiment, LI_X1 is an interface used for transport of X1 messages or information. Further, a transport layer may be utilized over a hypertext transfer protocol (HTTP) or hypertext transfer protocol secure (HTTPS) over a transmission control protocol (TCP).

In an embodiment, transport security (TLS) is configured to provide authentication, authorization, integrity, and confidentiality as well as replay protection between the TLS endpoints.

In an embodiment, provisioning over LI_X1 is provisioned via the IRI-POI in the system (110) that may support the multiple target identifier formats in the messages. The identifier formats may include but not limited to subscriber permanent identifier international mobile subscriber identity (SUPIIMSI), subscriber permanent identifier network access identifier (SUPINAI), permanent equipment identifier international mobile equipment identity (PEIIMEI), permanent equipment identifier international mobile equipment identity software version (PEIIMEISV), general public subscription identifier mobile station integrated services digital network (GPSIMSISDN), and global positioning system network access identifier (GPSINAI). If service scoping is to be performed at the IRI-POI in the system (110), the IRI-POI in the system (110) supports various CSP service types including messaging.

Further, in an embodiment, if the IRI-POI in the system (110) receives an ActivateTask message and the ListOfServiceTypes parameter contains a ServiceType that is not supported, the IRI-POI in the system (110) shall reject the task with an appropriate error.

In an embodiment, an intercepted traffic is delivered by the NE to a destination. Each destination is uniquely identified by a destination identifier (DID) and handled independently from the details of a task. Each task is associated with one or more destinations. Prior to associating a task with a given DID, it may be required that a destination with the DID may already be created but there is no requirement that a connection may have been successfully established for that DID.

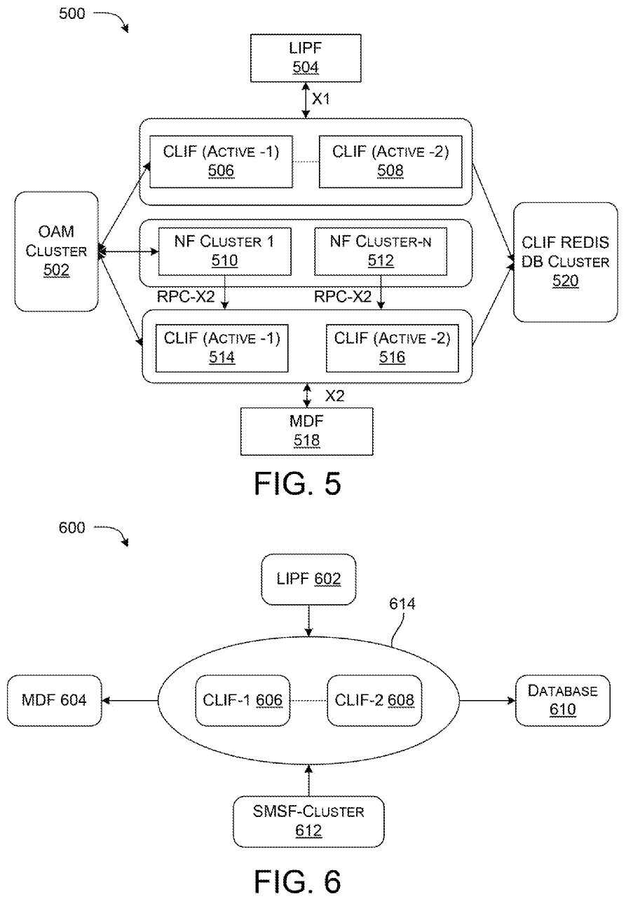

FIG. 5 illustrates an exemplary centralized lawful interception function (CLIF) architecture (500) and deployment, in accordance with an embodiment of the present disclosure.

In an embodiment, a centralized solution such as the CLIF helps in streamlining of LI provisioning to a single NF or a cluster of NFs efficiently. Further, as all the provisioning requests may be handled and limited to CLIF system only and may not be extended to the NFs. All procedures pertaining to the provisioning and interception may be offloaded to the centralized solution and an application may be made lightweight. Furthermore, the centralized solution may be used in any node.

As illustrated in FIG. 5, CLIF clusters (CLIF Active-1 (506), CLIF Active-2 (508), CLIF Active-3 (514), 5 CLIF Active-4 516) may be deployed as an active-active solution for high availability (HA). At the CLIF's, the provisioning leg may be independent of the underlying NF. However, interception feeds may be dependent on a node functionality i.e., the scope of system/SMSF (110) may revolve around X1 feeds only whereas service capabilities exposure function/network exposure function (SCEF/NEF) nodes may revolve around xIRI and xCC feeds. For communicating xIRI, an X2 protocol may be used with MDF2 as the point of interconnection. Further, for communicating with xCC, an X3 protocol may be used with MDF3 as the point of interconnection. For an initial scope, X2 may be taken up and X3 may be integrated at a later point.

As illustrated in FIG. 5, CLIF clusters (CLIF Active-1 (506), CLIF Active-2 (508), CLIF Active-3 (514)) and NF clusters (NF cluster 1 (510), NF cluster 2 (512)) can accessed by an operations, administration, and maintenance (OAM) cluster (502). Further, the LIPF (504) access the CLIF clusters (CLIF Active-1 (506), CLIF Active-2 (508)) via the X1 interface. Additionally, the MDF (518) may access the CLIF clusters (CLIF Active-3 (514), CLIF Active-4 (516)) via the X2 interface. The CLIF clusters (CLIF Active-1 (506), CLIF Active-2 (508), CLIF Active-3 (514)) store the processed information in a CLIF remote dictionary server (REDIS) DB cluster (520). Further, the NF clusters (NF cluster 1 (510), NF cluster 1 (512)) access the CLIF clusters CLIF Active-3 (514), CLIF Active-4 (516)) via an interface remote procedure call (RPC-X2).

FIG. 6 illustrates an exemplary short message service function (SMSF) integration with the CLIF (600), in accordance with an embodiment of the present disclosure.

As illustrated in FIG. 6, the SMSF cluster (612) provides lawful interception with the help of the CLIF micro-service. The SMSF (612) is configured to cooperate with the ADMF to receive the generated tracing request and is further configured to receive a user activation signal along with at least one user equipment (UE) identifier from the target UE through a network function. The SMSF cluster (612) and the CLIF cluster (614) (having (CLIF-1 (606), CLIF-2 (608)) use a customized communication fabric to pass on information regarding mobile operating (MO) and mobile terminating (MT) messages of the target identifier. Further, the LIPF (602) access the CLIF cluster (614) (CLIF-1 (606), CLIF-2 (608)) using X1 provisioning.

The following steps are utilized for integration of the SMSF cluster (612) with the CLIF cluster (CLIF-1 (606), CLIF-2 (608)).

At step 614: Provisioning is initiated by the LIPF (602) using X1 interface. Provisioning may contain the computing device identifier, the message type (X2), and the destination ID (e.g.: MDF 2 instance). The provisioning is basically a request for tracing a sender and receiving user equipment (UE)/computing device (104).

At step 616: The provisioning information is stored in a database (DB) (610) and cache files.

At step 618: The SMSF cluster (612) receives user activation (with identifiers, for e.g.,: SUPI, GPSI, and IMEI).

At step 620: The SMSF cluster (612) forwards this information to CLIF clusters (CLIF-1 (606), CLIF-2 (608)) and map the identifiers in the DB (610).

At step 622: Upon receipt of a MO/MT message on the SMSF cluster (612), the MO/MT message contains the details of the receiving and the sending UE.

At step 624: The identifiers are sent to the CLIF clusters (CLIF-1 (606), CLIF-2 (608)) and an actual message are sent towards calling line identity presentation (CLIP) along with a public land mobile network (PLMN).

At step 626: The CLIF clusters (CLIF-1 (606), CLIF-2 (608)) identify and derive the identifiers stored previously in the database DB (610), along with PLMN, and hence all the related details of both the UEs may get identified and traced.

At step 628: The CLIF clusters (CLIF-1 (606), CLIF-2 (608)) then verify if any provisioning (request) was made for any of the identifiers of the related UEs. If provisioning is found in DB (610), then an X2 feed is sent to MDF (604) by looking at the destination ID.

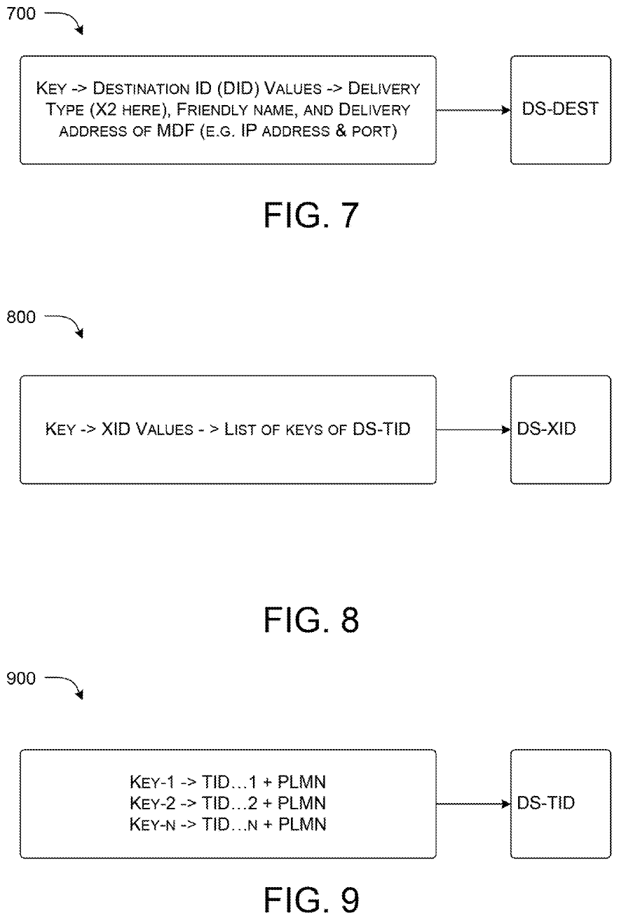

FIG. 7 illustrates an exemplary X1 destination identification (ID) provisioning (700), in accordance with an embodiment of the present disclosure.

As illustrated in FIG. 7, as LIPF system sends X1 Destination ID Provisioning request to CLIF via HTTP/HTTPS protocol. Further, the CLIF maps the destination details corresponding to the destination ID. This mapping is stored in both cache and database.

FIG. 8 illustrates an exemplary X1 activate task provisioning (800), in accordance with an embodiment of the present disclosure.

As illustrated in FIG. 8, apart from the activate task provisioning data, the LIPF also provides the PLMN information where the target identifier has to be intercepted. Further, CLIF may maintain the mappings in case of this provisioning application programming interface (API). The DS-XID data structure is maintained so that later on the task is modified or deactivated based on the ‘XID’ as a reference. The values of this data structure may include a list of keys of the second data structure ‘DS-TID’ which may have a composite key of TID and PLMN.

FIG. 9 illustrates an exemplary destination ID (DS-TID) data structure (900), in accordance with an embodiment of the present disclosure.

As illustrated in FIG. 9, the DS-TID data structure may include multiple keys for a single provisioning request from the LIPF as there are multiple target identifiers (TIDs). However, each of these keys is mapped to same value. For e.g., if the activate task has both SUPI and GPSI as target identifiers, both these target IDs are mapped to same ‘activate task’ data. Further, both of the mappings are stored in both cache and database.

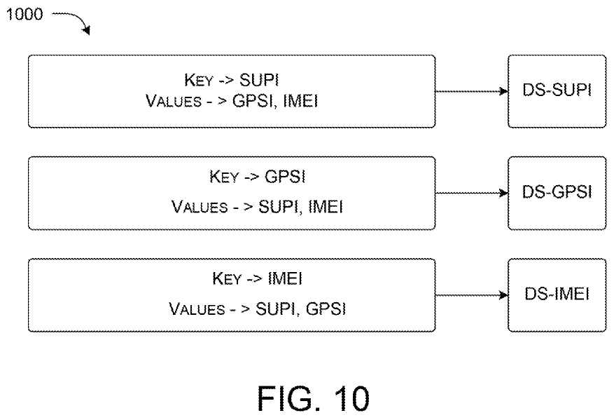

FIG. 10 illustrates an exemplary user activation on SMSF (1000), in accordance with an embodiment of the present disclosure.

As illustrated in FIG. 10, the SMSF does not maintain any mappings related to lawful interception. The SMSF sends an event for each mobile originated (MO) and mobile terminated (MT) message to CLIF over communication fabric. The event may either include SUPI or GPSI or both of the UE identifiers of originating as well as terminating UE. Further, the event may include message payload, location information, PLMN information, and other relevant feed data. CLIF may have the knowledge of all the three identifiers of both the UEs involved in the communication. Hence, to derive the rest of the identifiers, the CLIF may query DS-SUPI or DS-GPSI data structures for both the UEs. For each of the three identifiers of a UE, the CLIF may query DS-TID data structure by concatenating PLMN to find out if any provisioning was performed for that target identifier. If provisioning data is found, the CLIF may figure out the list of data identifications (DIDs) to which the X2 feed has to be sent. Further, the CLIF may query DS-DEST data structure to find out the address details of the DIDs. For each of the DIDs, the CLIF may send an X2 feed to MDF system over (TCP/transport layer security (TLS)).

In an embodiment, a single CLIF cluster for all 8 super cores deployment [multiple locations] may depend on a benchmarking performance. The CLIF may have an active-active cluster deployment with 2 nodes where the CLIF nodes may interact with its own REDIS data base cluster. Further, the CLIF may also interact with its own OAM for sending fault, configuration, accounting, performance, and security (FCAPS). For each cluster of the CLIF 2 virtual machines (VMs) for CLIF application, 7 VMs for REDIS DB, and 2 VMs for the OAM cluster are required. An elastic load balancing (ELB) solution is used on northbound connectivity/incoming traffic. Further, the CLIF may consist of inter cluster remote procedure calls (RPC) module for interacting with the SMSF, Further, an intra cluster RPC module may include the CLIF node cluster and HTTP1/HTTPS stack to interact with the LIPF. Also, TCP over TLS is used for secured communication with MDFs. Further, the LIPF may communicate with CLIF over HTTP and HTTPS for security where secure sockets layer (SSL) certificates management with prior sharing of certificates or an automated mode are utilized.

In an embodiment, responsibilities on the CLIF may include the processing of X1 messages including destination management and task management requests. At time of activate task, the CLIF may maintain data resolution of SUPI, GPSI and PEI. The CLIF may identify the match of target for incoming data from NE and if matched an interception is performed. Further, the CLIF may perform processing on the data received from NE over RPC and create X2 messages. CLIF may also forward X2 messages to identified MDF over a secured TCP connection where X2 messages must be re tried upon delivery failure due to destination issues. CLIF may store the X2 message data in its DB and may retry messages based on the configured mechanism.

In an embodiment, the L1_X1 interface may include X1 messages that may consist of messages for creating destination to forward X2/X3 messages, provisioning of target, modifying target, and deletion of target. Further, a transport layer is utilized with the HTTPS over TCP protocol. A TLS is used that provides authentication, authorization, integrity, and confidentiality as well as replay protection between the TLS endpoints. Javascript object notation (JSON) encoding is used by the L1_X1 interface. Additionally, the IRI-POI in the SMSF may support the target identifier in the messages in the format that may include but not limited to SUPIIMSI, SUPINAI, PEIIMEI, permanent equipment identifier international mobile equipment identity-software version (PEIIMEISV), general public subscription identifier mobile station integrated services digital network (GPSIMSISDN), and GPSINAI. If service scoping is to be performed at the IRI-POI in the CLIF, then the IRI-POI in the CLIF/SMSF may support the various CSP service types including messaging. Further, if the IRI-POI in the CLIF receives an ActivateTask message and the ListOfServiceTypes parameter contains a ServiceType that is not supported, the IRI-POI in the CLIF may reject the task with an appropriate error.

In an embodiment, the LIPF may send, create, modify, or remove destination requests to CLIF to create or remove MDF2/MDF3 details. Further, LIPF may send create, modify, or remove task request to the CLIF. The task may relate to a single target identifier to intercept the target and may respond from the point an ActivateTask Request is sent by the provisioning function to the time a deactivatetask request is sent. The LIPF may send requests to fetch information on tasks, destinations, and NF (SMSF) states. The NE may send report issue requests to the LIPF for reporting any issues in destination, tasks, or a NE health.

In an embodiment, the LI_X2 Interface may include multiple scenarios for xIRI generation. The IRI-POI in the SMSF may generate a xIRI containing an SMSMessage record for the multiple cases. A SMS-MO case is identified when a target UE may originate an SMS message or when any UE originates an SMS message destined to a target non-local ID.

In an embodiment, a SMS-MT case is identified when a SMS message delivery to a target UE is attempted or when an SMS message delivery originated from a target non-local ID is attempted to any UE. Further, the SMS-MT case is identified when an SMS message is successfully delivered to a target UE or when an SMS message originated from a target non-local ID is successfully delivered to any UE. The SMS-MT case may also apply to the scenario when a receipt of SMS delivery from a far end is delivered successfully to the target UE or when a receipt of SMS delivery from a target non-local ID is successfully delivered to the originating UE.

In an embodiment, the IRI-POI present in the SMSF is configured to generate the xIRI containing the SMSMessage record when the IRI-POI detects that the SMSF has received an SMCP message CP-DATA_RP-DATA [SMS-SUBMIT, SMS-COMMAND] (via AMF in Nsmsf_SMService_UplinkSMS message) from a target UE. Further, the SMSF is configured to generate the xIRI containing the SMSMessage record when the IRI-POI may detect that the SMSF has received an SMCP message CP-DATA_RP-DATA [SMS-SUBMIT] (via AMF in Nsmsf_SMService_UplinkSMS message) from any UE with TP-DA field within the SMS-SUBMIT containing a target non-local ID and when the SMSF returns the SMCP: CP-ACK to that originating UE. The SMSF is configured to generate the xIRI containing the SMSMessage record when the IRI-POI may detect that the SMSF has received an SMCP message CP-DATA_RP-DATA [SMS-COMMAND] (via AMF in Nsmsf_SMService_UplinkSMS message) from any UE with TP-DA field within the SMS-COMMAND containing a target non-Local ID and when the SMSF returns the SMCP: CP-ACK to that originating UE.

Further, in an embodiment, the SMSF is configured to generate the xIRI containing the SMSMessage record when the IRI-POI may detect that the SMSF has received a transaction capabilities application part (TCAP) message MAP MT-FORWARD-SHORT-MESSAGE Request [SMS-DELIVER, SMS-STATUS-REPORT] destined to a target UE. Additionally, the SMSF may generate the xIRI containing the SMSMessage record when the IRI-POI may detect that the SMSF receives a TCAP message MAP MT-FORWARD-SHORT-MESSAGE Request [SMS-DELIVER] destined to any UE with the TP-OA field within the SMS-DELIVER containing a target non-local ID.

In an embodiment, the IRI-POI present in the SMSF may generate the xIRI containing the SMSReport record when it detects that the SMSF has sent a SMCP message CP-DATA_RP-ACK [SMS-SUBMIT-REPORT] (via AMF in Namf_Communication_N1N2MessageTransfer message) in response to a previously intercepted CP-DATA_RP-DATA. Further, the IRI-POI present in the SMSF may generate the xIRI containing the SMSReport record when it detects that the SMSF has sent a SMCP message CP-DATA_RP-ERROR [SMS-SUBMIT-REPORT] (via AMF in Namf_Communication_N1N2MessageTransfer message) in response to a previously intercepted CP-DATA_RP-DATA. Additionally, the IRI-POI present in the SMSF may generate the xIRI containing the SMSReport record when it detects that the SMSF has sent a TCAP message MAP MT-FORWARD-SHORT-MESSAGE Response [SMS-DELIVER-REPORT] in response to a previously intercepted MAP MT-FORWARD-SHORT-MESSAGE Request.

In an embodiment, if the IRI-POI is provisioned with the TruncateTPUserData parameter included and the IRI-POI is generating xIRI for the SMS-SUBMIT type or SMS-DELIVER type TPDUs, the IRI-POI may use the truncatedSMSTPDU (as described in table 6.2.5-7), otherwise, the IRI-POI may use the sMSTPDU.

In an embodiment, all the SMS MO/MT messages are forwarded to CLIF from SMSF over RPC. At CLIF, the target UE is identified, and interception is made for the messages of an intercepted target UE. Further, xIRI messages are forwarded to MDF2 over a secured TCP connection for the identified target UE. Also, xCC messages are forwarded to MDF3 over the secured TCP connection for the identified target UE.

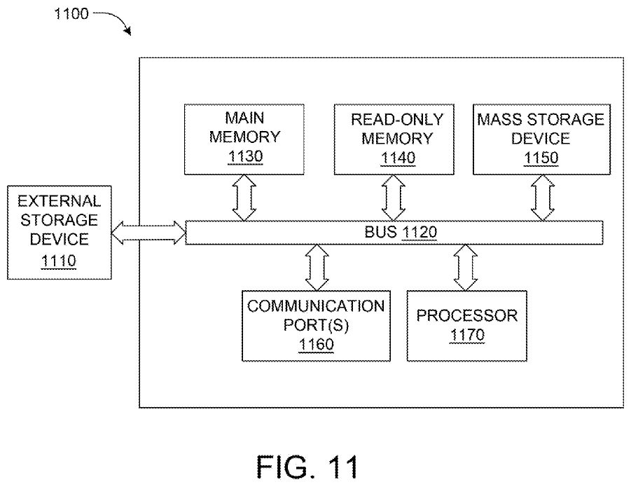

FIG. 11 illustrates an exemplary computer system (1100) in which or with which the system (110) is implemented, in accordance with an embodiment of the present disclosure.

As shown in FIG. 11, the computer system (1100) may include an external storage device (1110), a bus (1120), a main memory (1130), a read-only memory (1140), a mass storage device (1150), a communication port(s) (1160), and a processor (1170). A person skilled in the art will appreciate that the computer system (1100) may include more than one processor and communication ports. The processor (1170) may include various modules associated with embodiments of the present disclosure. The communication port(s) (1160) is any of an RS-232 port for use with a modem-based dialup connection, a 10/100 Ethernet port, a Gigabit or 10 Gigabit port using copper or fiber, a serial port, a parallel port, or other existing or future ports. The communication ports(s) (1160) is chosen depending on a network, such as a Local Area Network (LAN), Wide Area Network (WAN), or any network to which the computer system (1100) connects.

In an embodiment, the main memory (1130) is Random Access Memory (RAM), or any other dynamic storage device commonly known in the art. The read-only memory (1140) is any static storage device(s) e.g., but not limited to, a Programmable Read Only Memory (PROM) chip for storing static information e.g., start-up or basic input/output system (BIOS) instructions for the processor (1170). The mass storage device (1150) is any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (1120) may communicatively couple the processor(s) (1170) with the other memory, storage, and communication blocks. The bus (1120) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (1170) to the computer system (1100).

In another embodiment, operator and administrative interfaces, e.g., a display, keyboard, and cursor control device may also be coupled to the bus (1120) to support direct operator interaction with the computer system (1100). Other operator and administrative interfaces can be provided through network connections connected through the communication port(s) (1160). Components described above are meant only to exemplify various possibilities. In no way should the aforementioned exemplary computer system (1100) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

The present disclosure is configured to provide an enhancement to the SMSF such that the enhanced SMSF is able to provide lawful interception using a separate micro-service named centralized lawful interception function (CLIF). The SMSF to streamline of LI provisioning to a single NF or a cluster of NFs efficiently, as all the requests are handled by the CLIF system, thereby increasing the performance of a communication network. Lawful Interception (LI) is one of the regulatory requirements operators must satisfy as a legal obligation towards the Law Enforcement Agencies (LEA) and Government Authorities in most countries where they are operating their businesses. The present disclosure is applicable to a wide range of applications that require real-time lawful interception of the data.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method with a cost effective and a centralized solution that helps in streamlining of LI provisioning to a single network function (NF) or a cluster of NFs efficiently.

The present disclosure provides a system and a method with a centralized lawful interception function (CLIF) that manages provisioning and interception functions efficiently.

The present disclosure provides a system and a method for CLIF deployment and functioning.

The present disclosure provides a system and a method that may be adapted for any LI Solution, in any node.

The present disclosure provides a system and a method for integration with a LIM (lawful interception management).

The present disclosure provides a system and a method for an advanced communication system.

The present disclosure provides a system and method for enhancing and implementing one or more security related aspects in the communication system.

1. A system for providing centralized interception in a network, said system comprising:
an administration function (ADMF) configured to generate a tracing request for tracing a target user equipment (UE);
a short message service function (SMSF) configured to cooperate with said ADMF to receive said generated tracing request and is further configured to:
receive a user activation signal along with at least one user equipment (UE) identifier from said target UE through a network function;
store said received tracing request, and said received at least one user equipment (UE) identifier in a database;
receive an event for each mobile originated (MO) message and mobile terminated (MT) message from said network function;
forward said received tracing request and said received event for each MO message and MT message to a centralized lawful interception function (CLIF); and
said CLIF coupled to said SMSF to receive said tracing request and said event, and is configured to:
extract a plurality of information from said received event;
compare said at least one user equipment (UE) identifier stored in said database corresponding to said tracing request with said extracted plurality of information and traces all related details of said target UE and at least one UE communicating with said target UE to generate a provisioning information based on comparison; and
transmit said generated provisioning information to a law enforcement monitoring facility (LEMF), via an identified mediation and delivery function (MDF).

2. The system as claimed in claim 1, wherein said ADMF includes a lawful interception provisioning function (LIPF), and a lawful interception control function (LICF).

3. The system as claimed in claim 1, wherein said plurality of information includes at least one user equipment (UE) identifier of said target UE, at least one user equipment (UE) identifier of said at least one UE communicating with said target UE, message payload, location information, and public land mobile network (PLMN) information.

4. The system as claimed in claim 1, wherein said tracing request includes a public land mobile network (PLMN) identifier, a message type, a mediation and delivery function (MDF) identifier, and a correlation information.

5. The system as claimed in claim 1, wherein said SMSF sends said event for each mobile originated (MO) and mobile terminated (MT) message to said CLIF over a communication fabric.

6. The system as claimed in claim 1, wherein said at least one user equipment (UE) identifier includes a subscription permanent identifier (SUPI), a subscriber concealed identifier (SUCI), and a generic public subscription identifier (GPSI).

7. The system as claimed in claim 1, wherein said ADMF is configured to generate said tracing request for said target UE on receiving a warrant from a law enforcement agency (LEA).

8. (canceled)

9. The system as claimed in claim 1, wherein said CLIF is configured to transmit said generated provisioning information to said identified mediation and delivery function (MDF) over a secured Transmission Control Protocol (TCP) connection.

10. The system as claimed in claim 1, wherein said CLIF is configured to retransmit said generated provisioning information after a predefined time interval if any delivery failure occurred.

11. The system as claimed in claim 1, wherein said SMSF acts as a point of interception (POI) that derives said generated provisioning information from said CLIF and delivers said derived provisioning information to a plurality of mediation and delivery functions (MDFs).

12. The system as claimed in claim 1, includes a triggering function that is configured to receive said tracing request from LIPF and is further configured to trigger a POI based on type of data to be sent by said POI to said identified MDF.

13. A method of providing centralized lawful interception in a network, said method comprising:
generating, from an administration function (ADMF), a tracing request for tracing a target user equipment (UE);
receiving, by a short message service function (SMSF), said generated tracing request, receiving, by said SMSF, a user activation signal along with at least one user equipment identifier from said target UE through a network function;
storing, by said SMSF, said received tracing request, and said received at least one user equipment identifier in a database;
receiving, by said SMSF, an event for each mobile originated (MO) message and mobile terminated (MT) message from said network function;
forwarding, by said SMSF, said received tracing request and said received event to a centralized lawful interception function (CLIF);
extracting, by said CLIF, a plurality of information from said received event;
comparing, by said CLIF, said at least one user equipment identifier stored in said database corresponding to said tracing request with said extracted plurality of information and tracing all related details of said target UE and at least one UE communicating with said target UE to generate a provisioning information based on comparison; and
transmitting, by said CLIF, said generated provisioning information to a law enforcement monitoring facility (LEMF), via an identified mediation and delivery function (MDF).

14. The method as claimed in claim 13, further comprising sending said event for each mobile originated (MO) and mobile terminated (MT) message to said CLIF over a communication fabric.

15. The method as claimed in claim 13, further comprising generating, by said ADMF, said tracing request for said target UE on receiving a warrant from a law enforcement agency (LEA).

16. (canceled)

17. The method as claimed in claim 13, further comprising transmitting, by said CLIF, said generated provisioning information to said identified mediation and delivery function (MDF) over a secured Transmission Control Protocol (TCP) connection.

18. The method as claimed in claim 13, further comprising retransmitting, by said CLIF, said generated provisioning information after a predefined time interval if any delivery failure occurred.

19. The method as claimed in claim 13, further comprising deriving, by said SMSF acts as a point of interception (POI), said generated provisioning information from said CLIF and delivering said derived provisioning information to a plurality of mediation and delivery functions.

20. The method as claimed in claim 13, further comprising receiving, by a triggering function, said tracing request from LIPF and triggering a POI based on type of data to be sent by said POI to said identified MDF.

21. A centralized lawful interception function (CLIF) for providing centralized lawful interception in a network, said CLIF comprising a processing unit configured to:
receive, from an administration function (ADMF), a request for tracing a target user equipment (UE);
receive, via a short message service function (SMSF), an event for each mobile originated (MO) message and mobile terminated (MT) message from a network function;
extract a plurality of information from said received event;
compare, at least one user equipment identifier stored in a database corresponding to said tracing request with said extracted plurality of information and trace all related details of said target UE and at least one UE communicating with said target UE to generate a provisioning information based on comparison; and
transmit said generated provisioning information to a law enforcement monitoring facility (LEMF), via an identified mediation and delivery function (MDF).

22. A computer program product comprising a non-transitory computer-readable medium comprising instructions that, when executed by one or more processors, cause the one or more processors to execute a method for providing centralized lawful interception in a network, said method comprising:
generating, from an administration function (ADMF), a tracing request for tracing a target user equipment (UE);
receiving, by a short message service function (SMSF), said generated tracing request, receiving, by said SMSF, a user activation signal along with at least one user equipment identifier from said target UE through a network function;
storing, by said SMSF, said received tracing request, and said received at least one user equipment identifier in a database;
receiving, by said SMSF, an event for each mobile originated (MO) message and mobile terminated (MT) message from said network function;
forwarding, by said SMSF, said received tracing request and said received event to a centralized lawful interception function (CLIF); extracting, by said CLIF, a plurality of information from said received event;
comparing, by said CLIF, said at least one user equipment identifier stored in said database corresponding to said tracing request with said extracted plurality of information and tracing all related details of said target UE and at least one UE communicating with said target UE to generate a provisioning information based on comparison; and
transmitting, by said CLIF, said generated provisioning information to a law enforcement monitoring facility (LEMF), via an identified mediation and delivery function (MDF).
